(19) United States
(12) Patent Application Publication
(10) Pub. No.: US 2007/0296805 A1
(43) Pub. Date: Dec. 27, 2007

(54) MOBILE CONTENT SHARING

(75) Inventors: Mats TEDENVALL, Lund (SE); David CRONSTROM, Malmo (SE); Per Axel KROON, Bjarred (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/469,201

(22) Filed: Aug. 31, 2006

Related U.S. Application Data
(60) Provisional application No. 60/805,407, filed on Jun. 21, 2006.

(51) Int. Cl. H04N 7/14

(52) U.S. Cl. 348/14.01

(57) ABSTRACT

A telephone establishes a content sharing community with users associated with other telephones. The telephone stores content that includes video, a podcast, a TV program, or a link to a video, a podcast or a TV program and shares the content with another telephone associated with one user of the community of users.

### CROSS REFERENCE TO RELATED APPLICATION

The instant application claims priority from provisional application No. 60/805,407, filed Jun. 21, 2006, the disclosure of which is incorporated by reference herein in its entirety.

### TECHNICAL FIELD OF THE INVENTION

Implementations described herein relate generally to digital content and, more particularly, to sharing digital content between mobile devices.

### BACKGROUND

Streaming media typically includes audio and video transmitted over, for example, the Internet, in a streaming or continuous fashion. In streaming media applications, streaming audio and/or video data may be played back without the data being completely downloaded first. Streaming media may, thus, be viewed or listened to in “real-time” as the data is received. Streaming media may be user-controlled (e.g., on-demand, pay-per-view movies, etc.) or server-controlled (e.g., webcasting).

There are several Internet-based streaming services including, for example, audio books, news and podcasts. Podcasting may include the distribution of streaming audio and/or video data over the Internet for user viewing and/or listening. Podcasting typically involves a subscription feed of automatically delivered new audio and/or video content. Audio streaming (voice or music) may include the distribution of voice or music containing media over the Internet for user listening. Internet-based streaming services are in the process of being introduced into the mobile world.

### SUMMARY

According to one aspect, a method may include obtaining content at a first mobile telephone, where the content includes audio, video, a podcast, a TV program, or a link to a video, a podcast or a TV program. The method may further include sharing the content from the first mobile telephone to a second mobile telephone via a network.

Additionally, sharing the content may include sending the content to an intermediary server prior to the server sharing the content with the second mobile telephone.

Additionally, the method may further include sharing the content from the first mobile telephone to a third mobile telephone via the network.

Additionally, sharing the content from the first mobile telephone to a second mobile telephone may further include streaming the content to the second mobile telephone via the network.

Additionally, the TV program may include a digital video broadcasting—handheld (DVB-H) program.

Additionally, the method may further include establishing a community of users for sharing content, wherein sharing the content from the first mobile telephone to a second mobile telephone comprises sharing the content with a user of the community of users.

According to another aspect, a method may include storing content that includes at least one of a video, a podcast, a TV program or a link to a video, a podcast or a TV program at a first mobile telephone. The method may further include receiving a request to access the content from a second mobile telephone and sending the requested content to the second mobile telephone via a network based on the request.

Additionally, the method may further include establishing a community of users for sharing content and determining whether a user operating the second mobile telephone is a member of the community of users.

Additionally, the method may include sending the requested content to the second mobile telephone based on whether the user is a member of the community of users.

Additionally, the method may include receiving a second request to access the content from a third mobile telephone and sending the requested content to the third mobile telephone via the network based on the second request.

Additionally, the method may include establishing a community of users for sharing content and determining whether a user operating the third mobile telephone is a member of the community of users.

Additionally, sending the requested content may include sending the requested content to the third mobile telephone based on whether the user is a member of the community of users.

According to a further aspect, a method may include establishing a community of users and obtaining content at a first mobile telephone that includes a video, a podcast, a TV program, or a link to a video, a podcast or a TV program. The method may further include sharing the content with a second mobile telephone associated with one user of the community of users.

Additionally, establishing a community of users may include receiving authorization from each of the users of the community of users accepting membership in the community of users for sharing content.

Additionally, the method may include sharing the content with the second mobile telephone based on a request from the one user of the community of users.

Additionally, sharing the content with the second mobile telephone may further include sending the content to an intermediary server prior to the server sending the content to the second mobile telephone.

According to an additional aspect, a method may include sharing content from a first mobile telephone to a second mobile telephone and receiving images, via a camera at the second mobile telephone, when a user at the second mobile telephone views the shared content. The method may further include displaying the images at the first mobile telephone.

Additionally, the method may further include receiving a request from the second mobile telephone to access the content and sharing the content from the first mobile telephone to the second mobile telephone based on the request.

Additionally, the content may include at least one of a video, a podcast, or a TV program.

According to yet another aspect, a method may include receiving, at a server, content from a first mobile telephone, where the content includes at least one of a video, a podcast or a TV program, or a link to a video, a podcast or a TV program. The method may further include storing the content at the server and receiving a request from a second mobile telephone to access the content. The method may also include sending the content to the second mobile telephone via a network.

According to a further aspect, a mobile telephone may include means for storing content, where the content includes video, a podcast, a TV program, or a link to a video, a podcast or a TV program. The mobile telephone may further include means for sharing the content with another mobile telephone via a network.

According to an additional aspect, a telephone may include a processing unit configured to establish a content sharing community with users associated with other telephones. The telephone may further include a memory configured to store content that includes video, a podcast, a TV program, or a link to a video, a podcast or a TV program and a transceiver configured to share the content with another telephone associated with one user of the community of users.

It should be emphasized that the term “comprises/comprising” when used in this specification is taken to specify the presence of stated features, integers, steps, components or groups but does not preclude the presence or addition of one or more other features, integers, steps, components or groups thereof.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 illustrates an overview of an exemplary embodiment;

FIG. 2 illustrates an exemplary system in which aspects of the invention may be implemented;

FIG. 3 illustrates an exemplary system that includes a cellular network according to an exemplary implementation;

FIG. 4 illustrates an exemplary user device according to an exemplary implementation;

FIG. 5 is a flowchart of an exemplary content “push” sharing process consistent with exemplary embodiments;

FIG. 6 is a diagram depicting the establishment of a contact in a community of users consistent with an exemplary embodiment;

FIG. 7 is a diagram depicting the selection of content sharing via a user interface of a content sharing device consistent with an exemplary embodiment;

FIG. 8 is a diagram depicting the selection of content posting via a user interface of a content sharing device consistent with an exemplary embodiment;

FIG. 9A graphically illustrates “pushing” content from a content sharing device to a user device across a network consistent with an exemplary embodiment;

FIG. 9B graphically illustrates “pushing” content from a content sharing device to an intermediary server, and from the intermediary server to a user device consistent with an exemplary embodiment;

FIG. 10 is a flowchart of an exemplary content “pull” sharing process consistent with exemplary embodiments;

FIG. 11 is a diagram depicting the viewing and selection of content to pull from another mobile telephone consistent with an exemplary embodiment;

FIG. 12A graphically illustrates “pulling” content from a content sharing device to a user device consistent with an exemplary embodiment; and

FIG. 12B graphically illustrates “pulling” content from a content posting server to a user device consistent with an exemplary embodiment.

### DETAILED DESCRIPTION OF EMBODIMENTS

The following detailed description of the invention refers to the accompanying drawings. The same reference numbers in different drawings may identify the same or similar elements. Also, the following detailed description does not limit the invention.

Consistent with aspects of the invention, content may be shared between mobile devices, such as, for example, mobile telephones. Such content may include, for example, audio, video (e.g., streaming video), podcasts, or television (TV) programs (e.g., Digital Video Broadcasting-Handheld (DVB-H)), or links to video, podcasts or TV programs. Users may establish a community of users for sharing content, and then may share content with selected users in the community. Content may, thus, be exchanged between mobile devices associated with users who have accepted membership in the community of users. In some implementations, identifiers associated with the content (e.g., links) may be shared between mobile devices and not necessarily the content (e.g., video, podcasts, TV programs, etc.) itself.

Overview

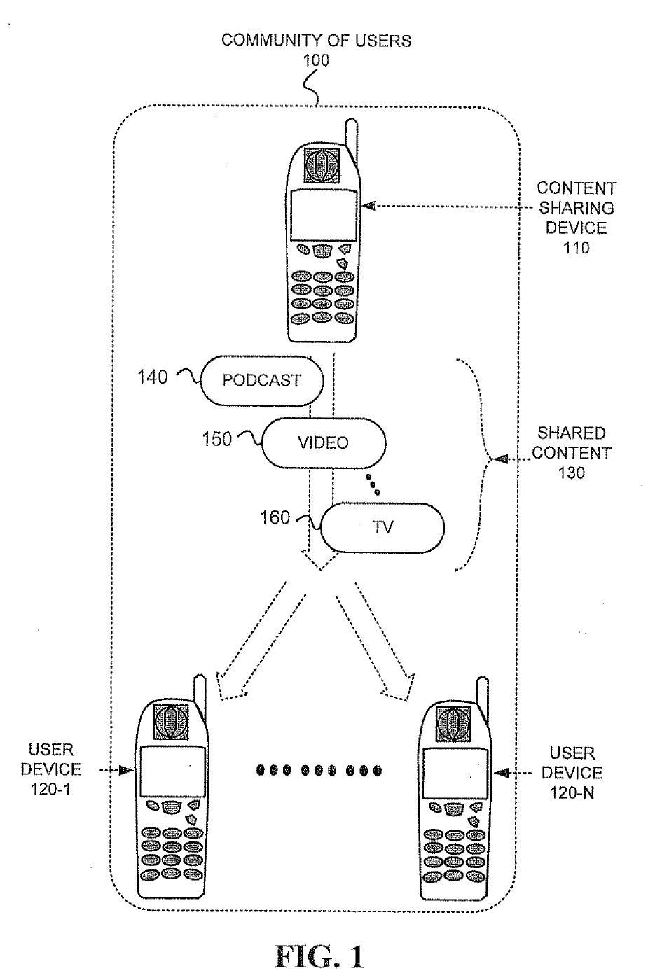

FIG. 1 illustrates an overview of an exemplary embodiment in which content is shared between devices, such as, for example, mobile telephones. A user using content sharing device 110 may subscribe or register, along with users using user devices 120-1 through 120-N (collectively referred to herein as “user devices 120”), to a community of users 100. As members of the community of users 100, the user of content sharing device 110 may share content 130 with any or all of the other users in the community of users 100. As shown in FIG. 1, content sharing device 110 and user devices 120-1 through 120-N may include mobile radiotelephones. Content sharing device 110 and user devices 120-1 through 120-N may include other devices, such as, for example, personal computers or Personal Communications System (PCS) terminals or the like. A PCS terminal may combine a cellular radiotelephone with data processing, facsimile and/or data communications capabilities. Content sharing device 110 and user devices 120-1 through 120-N may further include a personal digital assistant (PDA), a conventional laptop and/or palmtop receiver, or another appliance that includes a radiotelephone transceiver, or the like. A PDA may include a radiotelephone, a pager, Internet/intranet access, a web browser, an organizer, calendars and/or a global positioning system (GPS) receiver.

As shown in FIG. 1, shared content 130 may include, for example, a podcast 140, a video 150, or a TV program 160. Shared content 130 may include other types of content (not shown), such as, for example, one or more links to content (e.g., links to video, podcasts, TV programs, etc.) stored at a remote server (not shown). A “link,” as the term is used herein, is to be broadly interpreted to include any reference to content (e.g., a web page, a video file, a podcast, streaming video, etc.). In some implementations, a link may include a Uniform Resource Locator (URL) of content. User devices 120-1 through 120-N may receive shared content 130 from any device operated by users within community of users 100.

Exemplary System

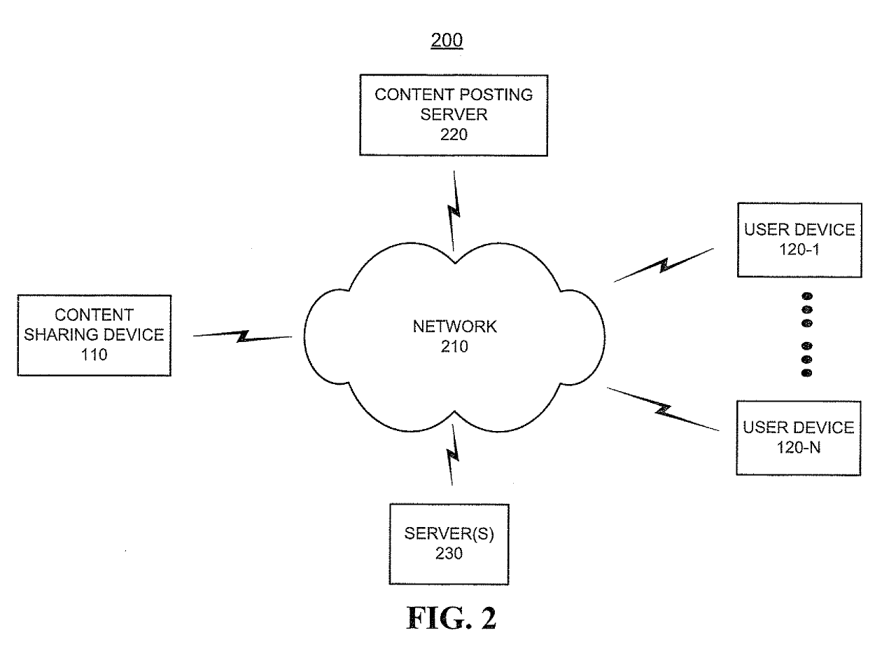

FIG. 2 illustrates an exemplary system 200 in which aspects of the invention may be implemented. System 200 may include content sharing device 110, user devices 120-1 through 120-N, content posting server 220, and server(s) 230 interconnected via a network 210.

Content posting server 220 may store content posted from content sharing device 110 for sharing with users within a designated community of users (e.g., with users operating user devices 120-1 through 120-N). Content posting server 220 may store any type of content posted by content sharing device I 10 including, for example, video files, streaming video, podcasts, DVB-H, images, or links to video files, streaming video, podcasts, images, etc. Server(s) 230 may store content that may be accessed by content sharing device 110 or user devices 120-1 through 120-N. Server(s) 230 may store, for example, video files, streaming video, podcasts, DVB-H, images, etc.

Network 210 may include one or more sub-networks of any type, including a local area network (LAN), a wide area network (WAN), a satellite network, a metropolitan area network (MAN), a telephone network, such as the Public Switched Telephone Network (PSTN) or a Public Land Mobile Network (PLMN), an intranet, the Internet, or a combination of networks. The PLMN(s) may further include a packet-switched sub-network, such as, for example, General Packet Radio Service (GPRS), Cellular Digital Packet Data (CDPD), or Mobile IP sub-network.

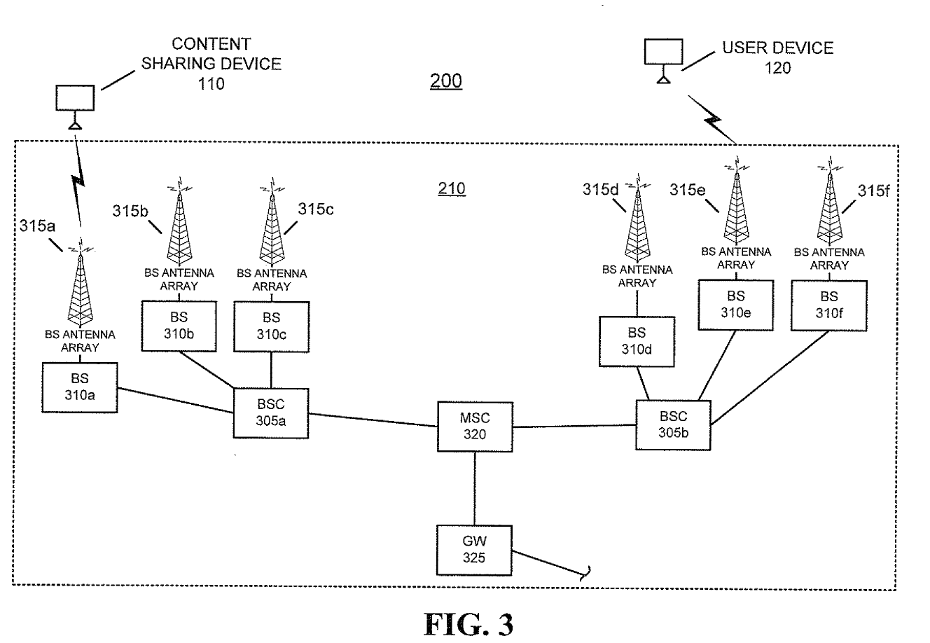

FIG. 3 illustrates one example of system 200 implemented using a cellular network. In system 200, as illustrated in FIG. 3, content sharing device 110 may include a mobile radiotelephone and network 210 may include a PLMN (e.g., a cellular telephone network). As shown, system 200 may include a user device 120 connected to cellular network 210. Cellular network 210 may include one or more base station controllers (BSCs) 305a and 305b, multiple base stations (BSs) 310a-310f, multiple base station antenna arrays 315a-315f, one or more mobile switching centers (MSCs), such as MSC 320, and one or more gateways (GWs), such as GW 325.

Cellular network 210 may consist of existing components used for transmitting data to and from content sharing device 110 and user device 120. Such components may include base station antenna arrays 315a-315f, which transmit and receive, via appropriate data channels, data from devices within their vicinity. Base stations 310a-310f connect to their respective antenna arrays 315a-315f, and format the data transmitted to, or received from the antenna arrays 315a-315f in accordance with existing techniques, for communicating with BSCs 305a-305b or a mobile station, such as content sharing device 1 10 or user device 120. Among other functions, BSCs 305a-305b may route received data to either MSC 320 or a base station (e.g., BSs 310a-310c or 310d-310f). MSC 320 routes received data to BSC 305a or 305b. GW 325 may route data received from an external domain (not shown) to an appropriate MSC (such as MSC 320), or from an MSC to an appropriate external domain.

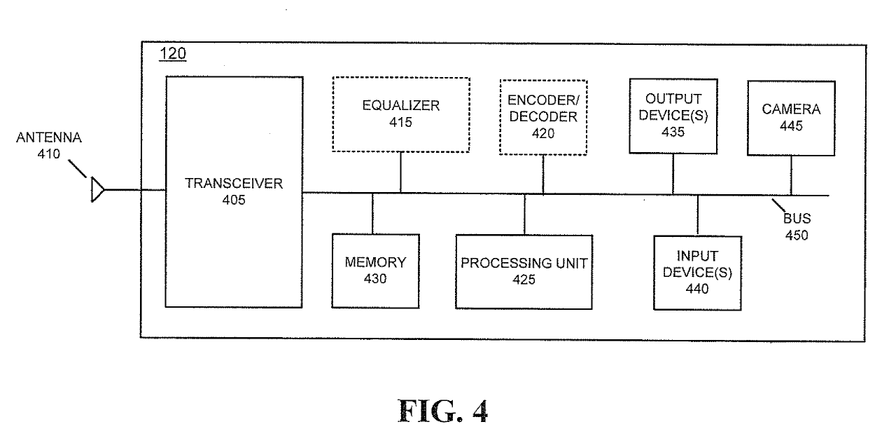

FIG. 4 illustrates an exemplary user device 120 consistent with exemplary embodiments. Content sharing device 110 may be similarly configured. User device 120 may include a transceiver 405, an antenna 410, an optional equalizer 415, an optional encoder/decoder 420, a processing unit 425, a memory 430, an output device(s) 435, an input device(s) 440, a camera 445 and a bus 450.

Transceiver 405 may include transceiver circuitry well known to one skilled in the art for transmitting and/or receiving symbol sequences in a network, such as network 2 1 0, via antenna 410. Transceiver 405 may include, for example, a conventional RAKE receiver. Transceiver 405 may further include mechanisms for estimating the signal-to-interference ratio (SIR) of received symbol sequences Transceiver 405 may additionally include mechanisms for estimating the propagation channel Doppler frequency.

Equalizer 415 may store and implement Viterbi trellises for estimating received symbol sequences using, for example, a maximum likelihood sequence estimation technique. Equalizer 415 may additionally include mechanisms for performing channel estimation.

Encoder/decoder 420 may include circuitry for decoding and/or encoding received or transmitted symbol sequences. Processing unit 425 may perform all data processing functions for inputting, outputting, and processing of data including data buffering and terminal control functions, such as call processing control, user interface control, or the like. Memory 430 provides permanent, semi-permanent, or temporary working storage of data and instructions for use by processing unit 425 in performing processing functions. Memory 430 may include large-capacity storage devices, such as a magnetic and/or optical recording medium and its corresponding drive. Output device(s) 435 may include mechanisms for outputting data in video, audio, and/or hard copy format. Input device(s) 440 permit entry of data into user device 120 and may include a user interface and a microphone (not shown). The microphone may include mechanisms for converting auditory input into electrical signals. Camera 445 may include any type of image producing mechanism, such as, for example, a typical camera built into a cellular radiotelephone.

Bus 450 interconnects the various components of user device 120 to permit the components to communicate with one another. The configuration of components of user device 120 illustrated in FIG. 4 is for illustrative purposes only. One skilled in the art will recognize that other configurations may be implemented.

Exemplary Content “Push” Sharing Process

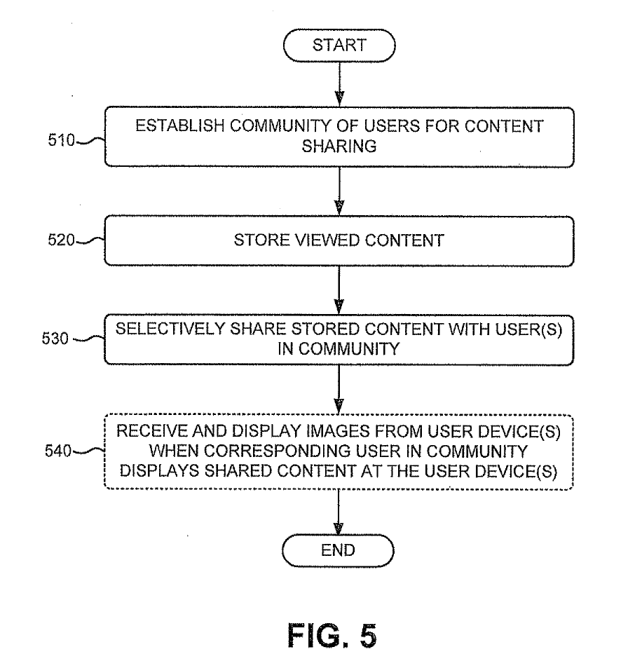

FIG. 5 is a flowchart of an exemplary process for sharing content by “pushing” the content from content sharing device 110 to a user device 120, or to content posting server 220, consistent with exemplary embodiments. Content sharing device 110 may implement the process exemplified by FIG. 5.

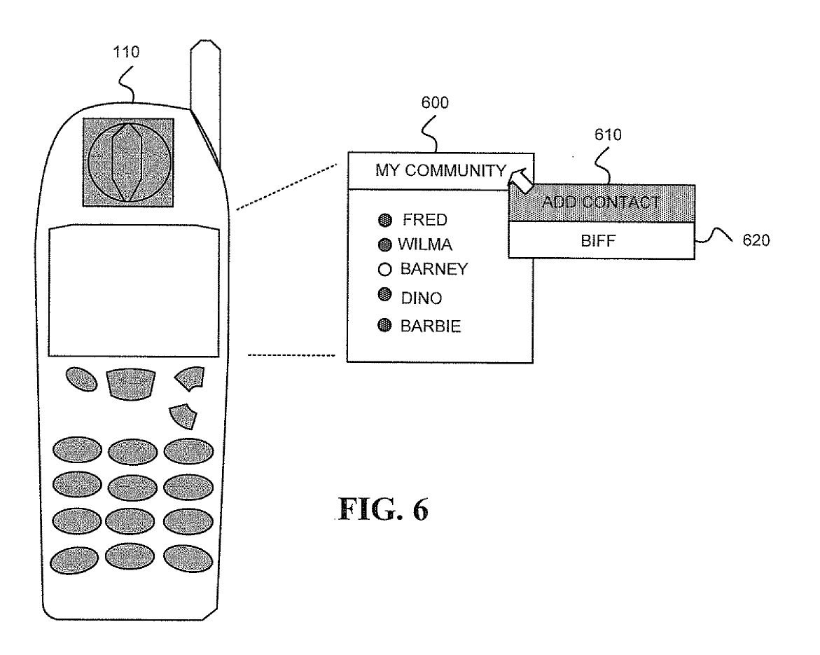

The exemplary process may begin with the establishment of a community of users for content sharing (block 510). Various techniques may be used for establishing a community of users. For example, as shown in FIG. 6, a user operating content sharing device 110 may access a “my community” window 600 and select an “add contact” 610 operation. The user may enter an identifier 620 associated with the other user that is desired to be added to the user's community of users. Subsequent to addition of a contact to a user's community of users, the contact may accept or reject addition to the community of users and, if accepted, the user may subsequently shared content with that contact.

Content viewed at content sharing device 110 may be stored (block 520). A user operating content sharing device 110 may download content from server(s) 230 and may store the content in memory 430 of content sharing device 110. For example, content sharing device 110 may download video files, streaming video, podcasts, etc. from server(s) 230. In some implementations, the stored content may include a link(s) to content viewed at content sharing device 110. For example, the link(s) may include a uniform resource locator(s) (URLs) associated with the content. In implementations that store links as content, the content downloaded by content sharing device 110 may only be stored temporarily while the content is being viewed by the user. The link(s) associated with the network location of the content, however may be stored at the content sharing device 110 for subsequent sharing with the community of users.

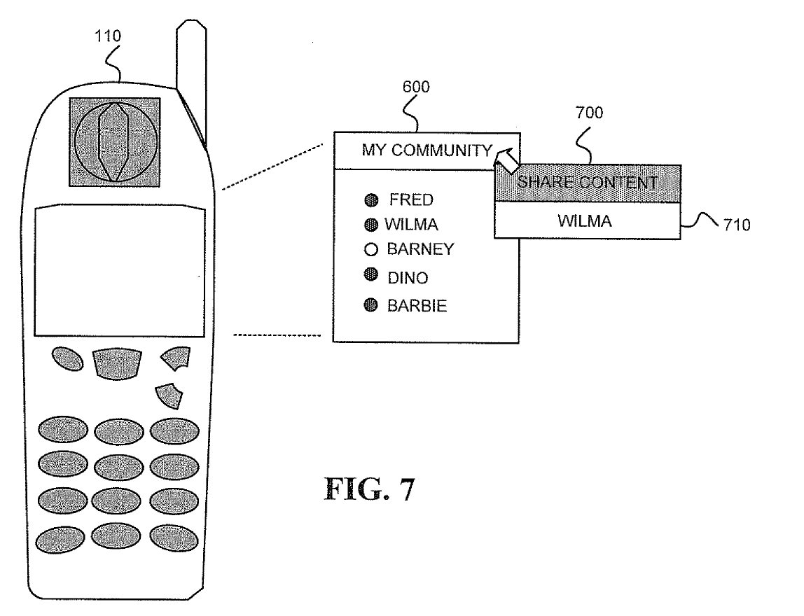

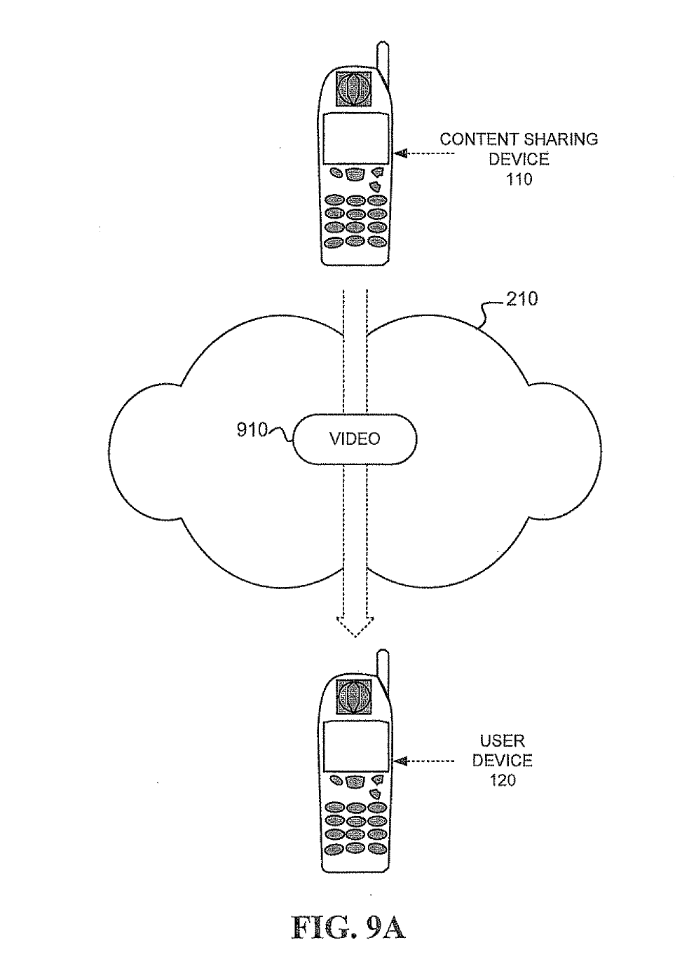

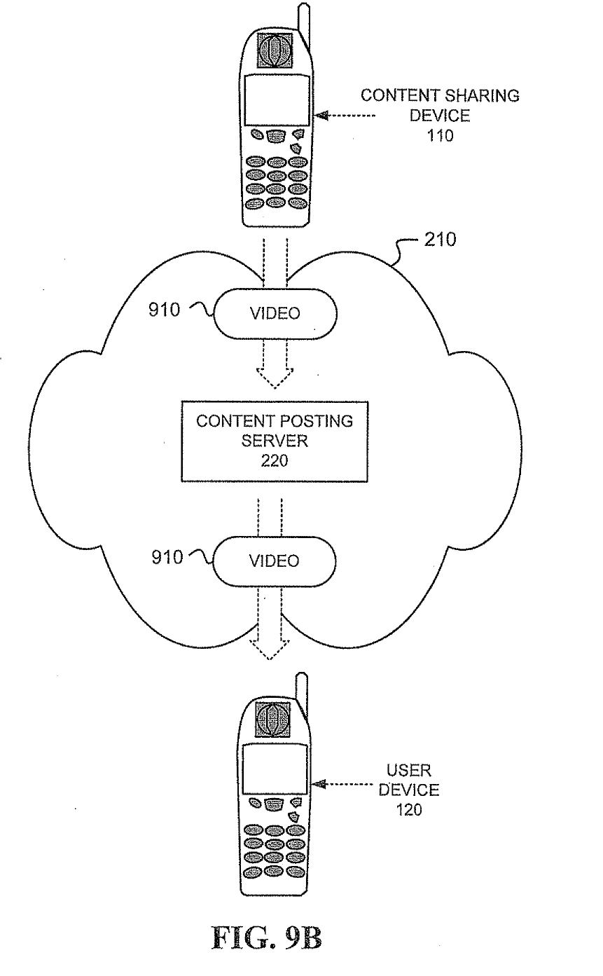

The stored content may be selectively shared with user(s) in the established community (block 530). In one exemplary implementation, content sharing device 10 may share content directly with a user device 120. For example, as shown in FIG. 7, a user operating content sharing device 110 may access “my community” window 600, that identifies all others users within that user's community of users, and may select a “share content” 700 operation. The user may enter, or select, an identifier 710 associated with the other user with whom the content is going to be shared. The user may additionally select items of content from memory 430 to share with the user identified by identifier 710. Content sharing device 110 may send the selected items of content (e.g., stream the content) to the user device 120 associated with the user identified by identifier 710 via network 210. Content sharing device 110 may send the selected items of content via, for example, BlueTooth or wireless local area network (WLAN). FIG. 9A depicts the “pushing” of content from content sharing device 110 directly to a user device 120. As shown in FIG. 9A, content sharing device 110 may transmit content 910 (video content shown by way of example) to user device 120 via network 210. In other implementations, after selection of items of content to be shared, content sharing device 110 may send links (e.g., URLs) associated with the selected items of content to the user device 120 associated with the user identified by the selected identifier 710 via network 210.

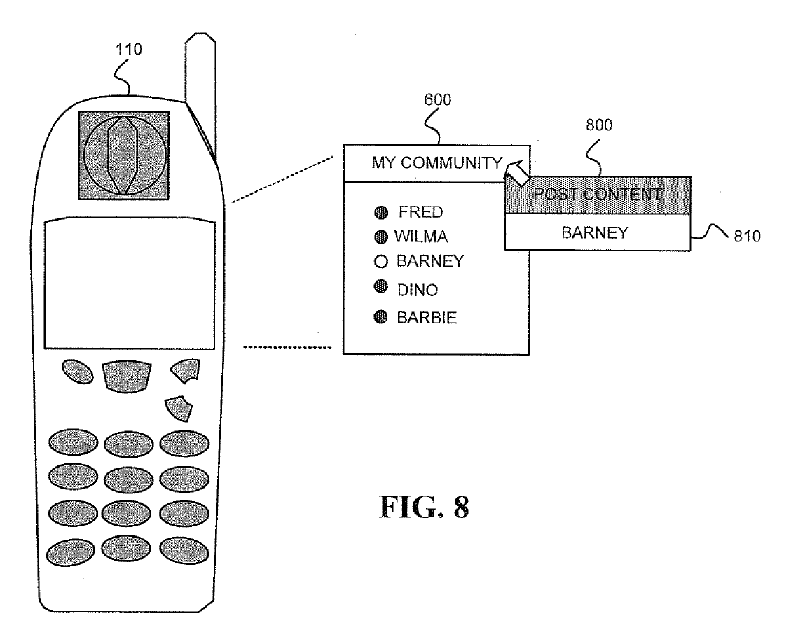

In another exemplary implementation, content sharing device 110 may share content with a user device 120 using content posting server 220 as an intermediary. For example, as shown in FIG. 8, a user operating content sharing device 110 may access “my community” window 600 and may select a “post content” 800 operation. The user may enter, or select, an identifier 810 associated with the other user with whom the content is going to be shared. The user may additionally select items of content from memory 430 to share with the user identified by identifier 810. Content sharing device 110 may then send the selected items of content for posting on content posting server 220. Content sharing device 110 may send the selected items of content (e.g., stream the content) via, for example, Bluetooth or wireless local area network (WLAN). The user identified by identifier 810 may subsequently receive the content from content posting server 220. FIG. 9B depicts the “pushing” of content from content sharing device 110 to a user device 120 indirectly through content posting server 220. As shown in FIG. 9B, content sharing device 110 transmits content 910 (video content shown by way of example) to content posting server 220 via network 210. Content posting server 220 subsequently forwards content 910 to user device 120 via network 210. In other implementations, after selection of items of content to be shared, content sharing device 110 may send links (e.g., URLs) associated with the selected items of content to content posting server, and the user identified by identifier 810 may subsequently receive the content from content posting server 220.

Images from a user device(s) 120 may be received and displayed when a corresponding user(s) in the community displays shared content at the user device(s) (optional block 540). Content sharing device 110, subsequent to sharing content with a user device 120, may receive images from the user device 120 permitting the user operating content sharing device 110 to view the face of the user operating user device 120 when the user operating user device 120 views the shared content. A camera 445 at user device 120 may generate the images and user device 120 may send the images to content sharing device 110 via network 210.

Exemplary Content “Pull” Sharing Process

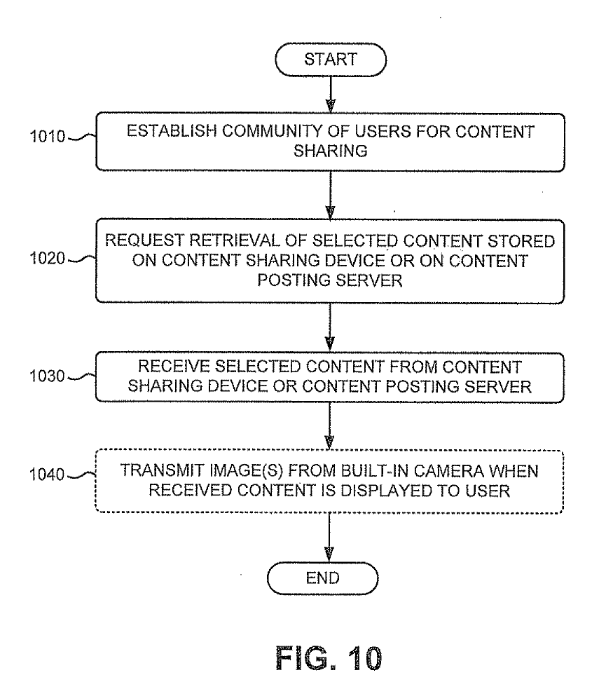

FIG. 10 is a flowchart of an exemplary process for sharing content by “pulling” content from content sharing device 110 by a user device 120 consistent with exemplary embodiments. A user device 120 may implement the process exemplified by FIG. 10.

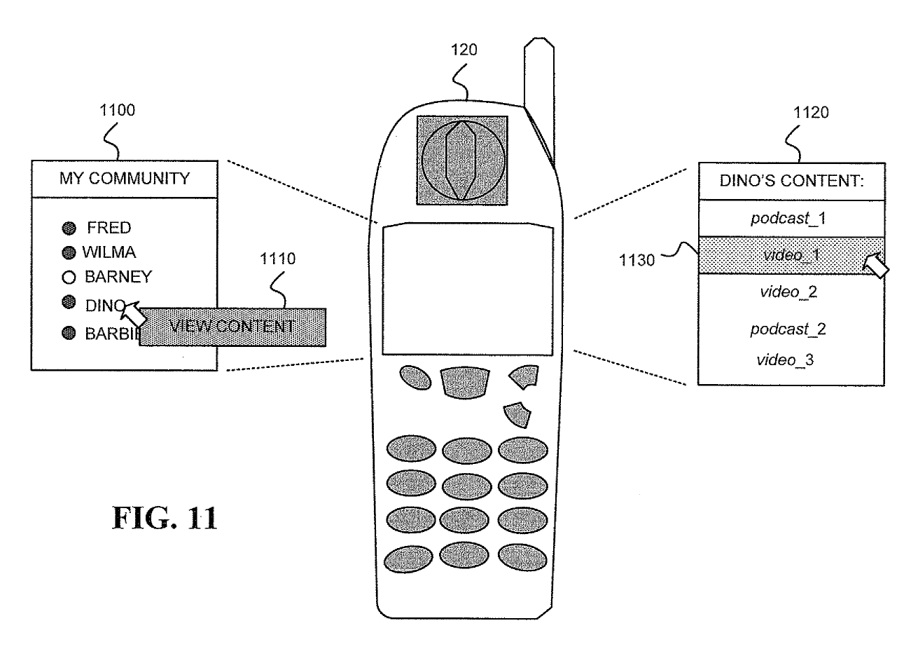

The exemplary process may begin with the establishment of a community of users for content sharing (block 1010). A user operating user device 120 may establish a community of users similar to that described above with respect to FIG. 6 and block 510 of FIG. 5. User device 120 may request retrieval of selected stored content from content sharing device 110 or content posting server 220 (block 1020). For example, as shown in FIG. 11, a user operating user device 120 may access a “my community” window 1100, that identifies all others users within that user's community of users, and may select a “view content” 1110 operation in association with a given user of the community of users. In response to selection of the “view content” 1110 operation, user device 120 may display a user content window 1120 that details a list of the content of the selected user that is available to be shared (e.g., content that the selected user has viewed). A specific item of content 1130 may be selected by the user from the user content window 1120, as shown in FIG. 11. The content that is available to be shared may include video files, streaming video, podcasts, etc. In some implementations, the content may include a link(s) to content. For example, the link(s) may include a uniform resource locator(s) (URLs) associated with the content.

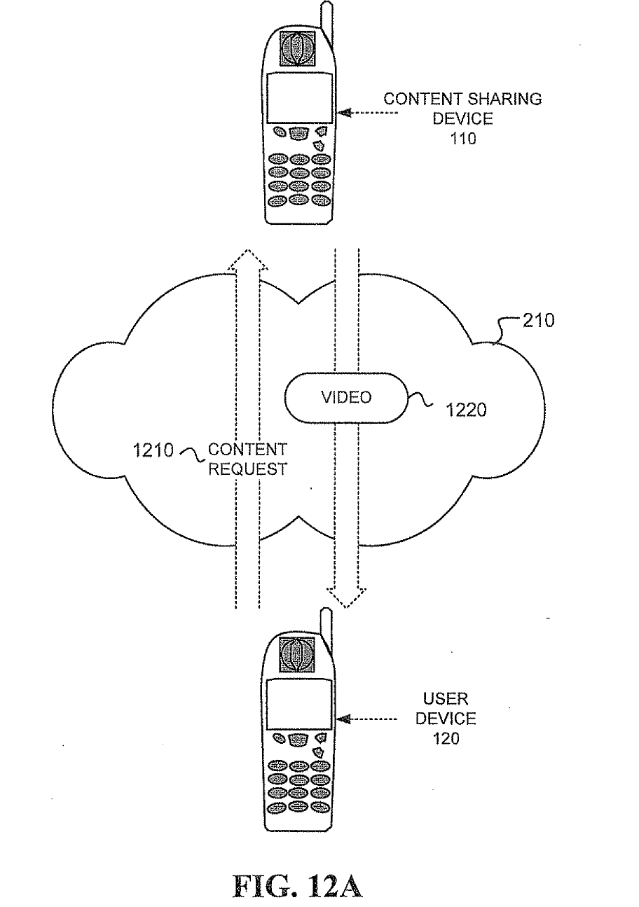

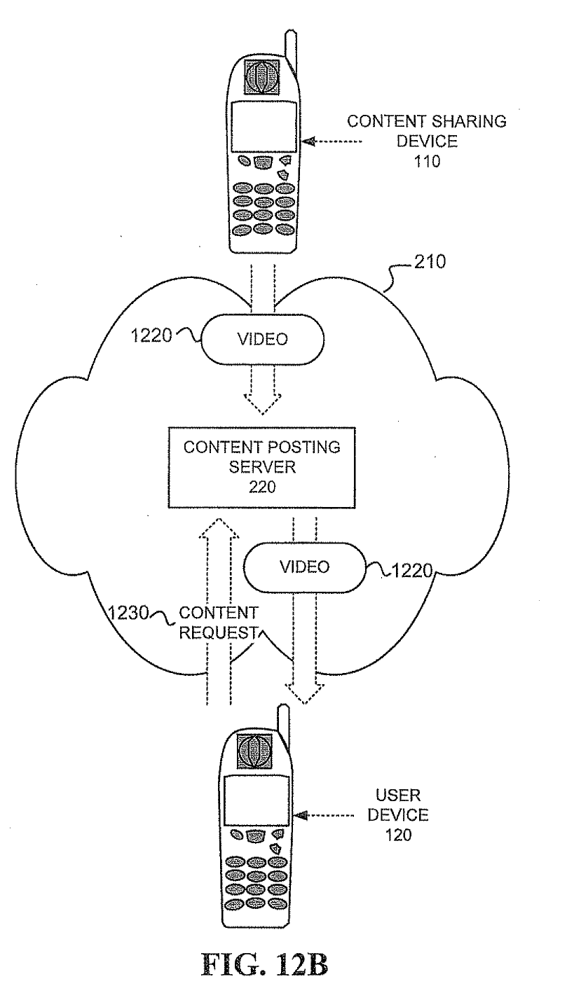

The selected content may be received from content sharing device 110 or content posting server 220 (block 1040). In one exemplary implementation, as shown in FIG. 12A, user device 120 may send a content request 1210 to content sharing device 110 via network 210 requesting access to a specific item(s) of stored content. In response, content sharing device 110 may return the requested content 1220 (video content by way of example) to user device 120 via network 210. Content sharing device 110 may return the requested content 1120 to user device 120 via, for example, Bluetooth or a wireless local area network (WLAN). In another exemplary implementation, as shown in FIG. 12B, content sharing device 110 may post content 1220 to content posting server 220 via network 210. Content sharing device 110 may post content 1220 to content posting server 220 via, for example, Bluetooth or a wireless local area network (WLAN). Subsequently, user device 120 may send a content request 1230 to content posting server 220 via network 210 requesting access to a specific item(s) of stored content. In response, content posting server 220 may return the requested content 1220 to user device 120 via network 210. For example, content posting server 220 may stream the requested content 1220 to user device 120.

User device 120 may transmit image(s) from built-in camera 445 to content sharing device 110 when the received content is displayed to the user operating user device 120 (optional block 1050). A user operating content sharing device 110 may, thus, watch the face of the user operating user device 120 when that user views the shared content.

Conclusion

The foregoing description of implementations consistent with principles of the invention provides illustration and description, but is not intended to be exhaustive or to limit the invention to the precise form disclosed. Modifications and variations are possible in light of the above teachings, or may be acquired from practice of the invention. For example, while a series of acts has been described with regard to FIGS. 5 and 10, the order of the acts may be modified in other implementations consistent with the principles of the invention. Further, non-dependent acts may be performed in parallel.

One skilled in the art will recognize that the principles of the present invention may be applied to any wired or wireless system utilizing any type of multi-access scheme, such as TDMA, CDMA or FDMA. It should be further understood that the principles of the present invention may be utilized in hybrid systems that are combinations of two or more of the above multi-access schemes. In addition, a communication device, in accordance with the present invention, may be designed to communicate with, for example, a base station transceiver using any standard based on GSM, TDMA, CDMA, FDMA, a hybrid of such standards or any other standard.

Aspects of the invention may also be implemented in methods and/or computer program products. Accordingly, the invention may be embodied in hardware and/or in software (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with principles of the invention is not limiting of the invention. Thus, the operation and behavior of the aspects were described without reference to the specific software code—it being understood that one of ordinary skill in the art would be able to design software and control hardware to implement the aspects based on the description herein.

Furthermore, certain portions of the invention may be implemented as “logic” that performs one or more functions. This logic may include hardware, such as an application specific integrated circuit or field programmable gate array, software, or a combination of hardware and software.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
obtaining content at a first mobile telephone, where the content includes audio, video, a podcast, a TV program, or a link to a video, a podcast or a TV program; and
sharing the content from the first mobile telephone to a second mobile telephone via a network.

2. The method of claim 1, wherein sharing the content comprises:
sending the content to an intermediary server prior to the server sharing the content with the second mobile telephone.

3. The method of claim 1, further comprising:
sharing the content from the first mobile telephone to a third mobile telephone via the network.

4. The method of claim 1, wherein sharing the content from the first mobile telephone to a second mobile telephone comprises:
streaming the content to the second mobile telephone via the network.

5. The method of claim 1, wherein the TV program is a digital video broadcasting—handheld (DVB-H) program.

6. The method of claim 1, further comprising:
establishing a community of users for sharing content, wherein sharing the content from the first mobile telephone to a second mobile telephone comprises sharing the content with a user of the community of users.

7. A method, comprising:
storing content that includes at least one of a video, a podcast, a TV program or a link to a video, a podcast or a TV program at a first mobile telephone;
receiving a request to access the content from a second mobile telephone; and
sending the requested content to the second mobile telephone via a network based on the request.

8. The method of claim 7, further comprising:
establishing a community of users for sharing content; and
determining whether a user operating the second mobile telephone is a member of the community of users.

9. The method of claim 8, further comprising:
sending the requested content to the second mobile telephone based on whether the user is a member of the community of users.

10. The method of claim 1, further comprising:
receiving a second request to access the content from a third mobile telephone; and
sending the requested content to the third mobile telephone via the network based on the second request.

11. The method of claim 10, further comprising:
establishing a community of users for sharing content; and
determining whether a user operating the third mobile telephone is a member of the community of users.

12. The method of claim 11, wherein sending the requested content comprises:
sending the requested content to the third mobile telephone based on whether the user is a member of the community of users.

13. A method, comprising:
establishing a community of users;
obtaining content at a first mobile telephone that includes a video, a podcast, a TV program, or a link to a video, a podcast or a TV program; and
sharing the content with a second mobile telephone associated with one user of the community of users.

14. The method of claim 13, wherein establishing a community of users comprises:
receiving authorization from each of the users of the community of users accepting membership in the community of users for sharing content.

15. The method of claim 13, further comprising:
sharing the content with the second mobile telephone based on a request from the one user of the community of users.

16. The method of claim 13, wherein sharing the content with the second mobile telephone comprises:
sending the content to an intermediary server prior to the server sending the content to the second mobile telephone.

18. A method, comprising:
sharing content from a first mobile telephone to a second mobile telephone;
receiving images, via a camera at the second mobile telephone, when a user at the second mobile telephone views the shared content; and
displaying the images at the first mobile telephone.

19. The method of claim 18, further comprising:
receiving a request from the second mobile telephone to access the content; and
sharing the content from the first mobile telephone to the second mobile telephone based on the request.

20. The method of claim 19, wherein the content comprises at least one of a video, a podcast, or a TV program.

21. A method, comprising:
receiving, at a server, content from a first mobile telephone, where the content includes at least one of a video, a podcast or a TV program, or a link to a video, a podcast or a TV program;
storing the content at the server;
receiving a request from a second mobile telephone to access the content; and
sending the content to the second mobile telephone via a network.

22. A mobile telephone, comprising:
means for storing content, where the content includes video, a podcast, a TV program, or a link to a video, a podcast or a TV program; and
means for sharing the content with another mobile telephone via a network.

23. A telephone, comprising:
a processing unit configured to establish a content sharing community with users associated with other telephones;
a memory configured to store content that includes video, a podcast, a TV program, or a link to a video, a podcast or a TV program; and
a transceiver configured to share the content with another telephone associated with one user of the community of users.
